(19) United States
(12) Patent Application Publication
(10) Pub. No.: US 2026/0347961 A1
(43) Pub. Date: Nov. 5, 2026

(54) QUENCHED AND PARTITIONED STEEL FOR AUTOMOBILES AND GRADIENT PARTITIONING PREPARATION METHOD THEREFOR

(71) Applicant: Angang Steel Company Limited, Anshan (CN)

(72) Inventors: Zhiping HU, Anshan (CN); Rendong LIU, Anshan (CN); Xingli GU, Anshan (CN); Jinyu GUO, Anshan (CN); Xin XU, Anshan (CN); Chunqing LIN, Anshan (CN)

(21) Appl. No.: 19/488,581

(22) PCT Filed: Jun. 8, 2023
(86) PCT No.: PCT/CN2023/099156

§ 371 Date: Nov. 26, 2025

(30) Foreign Application Priority Data
May 30, 2023 (CN) 202310625791.6

(51) Int. Cl. C21D 8/0221; C21D 8/021; C21D 8/0247; C22C 38/02; C22C 38/04; C22C 38/06; C22C 38/14

(52) U.S. Cl. CPC C21D 8/0236; C21D 8/021; C21D 8/0226; C21D 8/0273; C22C 38/02; C22C 38/04; C22C 38/06; C22C 38/14; C21D 2211/001; C21D 2211/002; C21D 2211/005; C21D 2211/008

(57) ABSTRACT

A quenched and partitioned steel for automobiles includes the following chemical components in percentage by mass: 0.17-0.24% of C, 1.60-2.40% of Mn, 0.80-1.80% of Si, 0.05-0.80% of Al, 0.015-0.025% of Ti, 0.007-0.012% of P, 0.001-0.004% of S, and a balance of Fe and inevitable impurities. A gradient partitioning preparation method includes: continuous casting, hot rolling, acid pickling, cold rolling, and continuous annealing/continuous annealing galvanizing. The present invention makes a breakthrough in the mechanism of action of QP steel by means of reasonable component and process design, and proposes a gradient partitioning process idea. The prepared QP steel product exceeds the international leading level compared with steel sheets of the same grade, and can be applied to more complex automotive structural members.

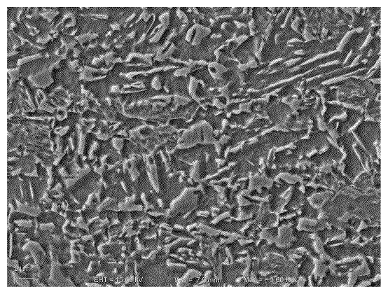

### TECHNICAL FIELD

The present invention belongs to the technical field of high-strength cold-rolled steel for automobiles, in particular to a quenched and partitioned steel for automobiles and a gradient partitioning preparation method therefor.

### BACKGROUND ART

Quenching and partitioning (Q & P) is a novel process proposed by Speer et al. in 2003 for producing high-strength and high-ductility steels with a mixed microstructure of martensite and retained austenite. The specific process route is as follows: Firstly, steels is austenitized or partially austenitized, then quenched to a temperature between the martensitic start (Ms) and martensitic finish (Mf) temperatures, followed by subjecting the steels to a brief holding period to obtain a certain amount of martensite and untransformed austenite. Subsequently, the steels is subject to isothermal partitioning treatment at a quenching temperature or a higher temperature, to achieve the diffusion and enrichment of carbon from supersaturated martensite into untransformed austenite, thereby stabilizing of the austenite. Finally, the steels is cooled to room temperature, resulting in a final microstructure including a mixed structure of martensite and retained austenite, or a mixed structure of ferrite, martensite and retained austenite. Among the third generation of advanced high-strength steels, high-strength steel products using the Quenching and Partitioning are regarded as Q & P steel. The gradual progress of global energy conservation and emission reduction promotes continuous development of automobile lightweight. The application proportion of the third generation of advanced high-strength steels in Body In White (BIW) has been gradually increasing. For instance, the usage of advanced high-strength steels in brands such as BMW, Toyota, and Mercedes-Benz has risen from around 5% in 2017 to over 15% in 2022. In China, the proportion of high-strength steels in newly launched models released by automakers like BYD and Geely has risen to about 30%. The gradual increase in the usage of advanced high-strength steels is mainly driven by the continuous optimization and improvement of their production and manufacturing technologies. The representative steel grade of the third generation of advanced high-strength steel is Q & P steel, which is also the most widely used, thoroughly researched, and industrially mature advanced high-strength steel product globally.

The Chinese standard GB/T20564.9 discloses the performance of steel Q & P 980 as follows: yield strength greater than or equal to 550 MPa, tensile strength greater than or equal to 980 MPa, and elongation after fracture greater than or equal to 18%. This steel can be used for relatively complex structural or reinforcing components in automotive bodies, such as inner and outer B-pillars and bumpers. However, it is obvious that the limited ductility of Q & P steel makes it difficult to meet the requirements for more complex structural applications, such as replacing DP780 steel, 420LA steel, or even DP590 steel. Japan's New Material Research Institute has proposed a plasticity target for 980 MPa-grade advanced high-strength steels in the future is 35%. If realized, 980 MPa-grade steels could replace almost all existing automotive structural components from a formability perspective. Of course, achieving a 35% plasticity target would require innovative design mechanisms and corresponding upgrades in equipment and processes. Therefore, given the current situation, reaching an plasticity of 25% to about 30% is a goal that may be achieved in the short term.

Chinese patent CN202010319605.2 discloses a method for preparing a 980 MPa-grade cold-rolled Q & P steel with excellent plasticity. The steel plate includes the following components in percentage by mass: 0.18-0.21% of C, 1.8-2.1% of Mn, 1.4-1.6% of Si, 0.02-0.06% of Al, less than or equal to 0.02% of P, less than or equal to 0.01% of S, 0.04-0.06% of Nb, and the balance of Fe and other inevitable impurities. The preparation method includes smelting, hot rolling, bell-type annealing, acid pickling, cold rolling, and continuous annealing. The obtained steel plate achieves a tensile strength of 982-1065 MPa and an elongation of 18.8-24.9%.

Chinese patent CN201810144307.7 discloses a 980 MPa-grade high-strength cold-rolled Q & P steel for automobiles and production method thereof. The steel includes the following alloy components in percentage by mass: 0.18-0.24% of C, 0.6-1.3% of Si, 1.6-2.4% of Mn, 0.04-0.07% of Nb, 0.5-1.0% of Als, 0.02-0.04% of P, less than or equal to 0.005% of S, and the balance of Fe and other inevitable impurities. The preparation method includes smelting, hot rolling, bell-type annealing, acid pickling, cold rolling, and continuous annealing. The obtained steel plate has a yield strength of greater than or equal to 550 MPa, a tensile strength of greater than or equal to 980 MPa, and an elongation of greater than or equal to 18%, with an maximum elongation of 23.5% in its embodiment. It can be seen that it is difficult for Q & P steel to achieve a plasticity index of greater than 25% based on the existing composition and process systems.

### SUMMARY

To address the above-mentioned technical problems, the present invention provides a quenched and partitioned steel for automobiles and a gradient partitioning preparation method therefor. Based on the existing equipment conditions, the present invention achieves higher plasticity index for Q & P steel products, thereby greatly improving their potential application in automotive body structures.

To achieve the above objectives, technical solutions of the present invention are as follows:

An aspect of the present invention is to provide a quenched and partitioned steel for automobiles. The quenched and partitioned steel includes the following chemical components in percentage by mass: 0.17-0.24% of C, 1.60-2.40% of Mn, 0.80-1.80% of Si, 0.05-0.80% of Al, 0.015-0.025% of Ti, 0.007-0.012% of P, 0.001-0.004% of S, and a balance of Fe and inevitable impurities.

In the above technical solutions, further, the chemical components of the steel further includes at least one of Ni, Cr, Mo, and Nb, with their contents in percentage by mass of 0.10-0.30% of Ni, 0.10-0.30% of Cr, 0.05-0.30% of Mo, and 0.015-0.025% of Nb, with a total mass of Mn, Ni, Cr and Mo of less than or equal to 2.50%.

In the above technical solutions, further, the steel has a yield strength of 600-700 Mpa, a tensile strength of 980-1100 Mpa, and an elongation of 25-30%.

In the above technical solutions, further, a microstructure of the steel is composed of, in percentage by volume, 40-60% of ferrite, 20-30% of martensite, 10-20% of bainite, and 10-20% of retained austenite. The ferrite is intercritical ferrite and epitaxial ferrite.

The selection principles of chemical components and reasons for the content design of the steel in the present invention are as follows:
C: C is the most economical strengthening element in steel, improving the hardenability of steel sheets, thereby enhancing the strength of steel sheets. In the Q & P steel of the present invention, C is the most critical factor, influencing the phase transformation behavior of the undercooled austenite. During the cooling stage, the relative enriched C in the undercooled austenite ensures the martensite content transformed during the transformation process. At the same time, the stability of untransformed undercooled austenite is enhanced during the isothermal partitioning stage through carbon diffusion from the surrounding martensite, thereby retaining it as retained austenite. However, excessively high C content will increase the risk such as hot-rolled edge cracking and cold-rolled edge cracking in industrial production. In addition, excessively high C content will lead to the formation of a high proportion of twin martensite at spot welding nuggets, deteriorating welding performance. Therefore, in the present invention, the content of C element is controlled within 0.17-0.24%.
Mn: Mn element is a common and economical strengthening element in steel, enhancing solid solution strengthening effect and improving the hardenability of steel sheets, thereby heightening its overall strength. In the Q & P steel of the present invention, Mn element primarily serves to reduce critical cooling rate and increase the proportion of martensite during the rapid cooling stage. Mn element also works in conjunction with C to improve the stability of austenite phase. However, the Mn content should not exceed the range specified in the present invention, as excessive Mn can lead to C/Mn segregation issues. Therefore, in the present invention, the Mn content is controlled within the range of 1.60-2.40%.
Si: Si element is a common and economical strengthening element in steel that ensures the matrix strength of ferrite. In addition, the addition of Si will increase the AC3 point of steel sheets, effectively adjusting the annealing process window during continuous annealing stage and ensuring an appropriate ratio of ferrite to austenite in the critical zone under industrial continuous annealing temperatures. In the Q & P steel of the present invention, the primary role of a sufficient Si content is to inhibit the formation of carbides during over-aging stage, preventing a decline in performance of steel sheets due to carbide precipitation. It should be noted that for galvanized products, excessive Si content should be avoided as it can lead to surface quality issues such as “skip plating” during galvanizing. Therefore, in the present invention, the Si content is controlled within the range of 0.80-1.80%.
Al: Al is added in limited amounts in conventional steel sheets, generally serving as a deoxidizer during smelting process. In the present invention, a higher content of Al is added during the production and manufacturing stage of galvanized products to replace Si, which helps inhibit the precipitation of carbides. However, the amount of Al replacing Si should not be too high, as excessive addition will cause difficulties in steel tapping during the continuous casting crystallization stage, an upward shift in the soaking window of continuous annealing/annealing galvanizing, and increased production challenges, among other issues. In the present invention, the Al content is controlled within the range of 0.05-0.80%
Ti: In conventional steel sheets, the effect of Ti is to fix nitrogen. In the present invention, an appropriate amount of Ti element is added as a strength supplement. For some planned components that cannot meet the strength requirements, the precipitation of Ti element serves to refine the original austenite grains, achieving fine-grain strengthening, and to provide precipitation strengthening to supplement the strength. In the present invention, the Ti content is controlled within the range of 0.015-0.025%.
P: P element is an impurity element in steel that tends to segregate at grain boundaries. When the P content in steel is high, it easily forms Fe₂P particles, reducing the plasticity and toughness of the steel. Therefore, a lower P content is preferred. In the present invention, the P content is controlled within the range of 0.007-0.012%.
S: S element is an impurity element in steel that easily combines with Mn to form MnS inclusions, which deteriorate the plasticity of steel sheets. Therefore, a lower S content is preferred. In the present invention, the S content is controlled within the range of 0.001-0.004%.

Among the additional elements that can be added:
Ni: Ni is inherently a solid solution strengthening element that, like C and Mn, enhances the stability of austenite. At the same time, Ni improves the corrosion resistance of steel sheets to some extent. In an optional composition of the present invention, an appropriate amount of Ni can be added to enhance corrosion resistance. In the present invention, the Ni content is controlled within the range of 0.10-0.30%.
Cr and Mo: Both Cr and Mo are solid solution strengthening elements, which contribute to the strengthening of steel sheets. In the present invention, Cr and Mo can enhance the hardenability of the steel sheets, delay the formation of pearlite and bainite during cooling stage, and promote the formation of martensite. Additionally, Cr and Mo can change the type of iron oxide scale formed during coiling process, restrict internal oxidation of the steel sheets, and improve the surface quality of the sheets. In the present invention, Cr and Mo are added after Mn to balance problems of hot-rolled edge cracks and cold-rolled edge cracking. Therefore, in the present invention, the Cr content is controlled within the range of 0.10-0.50%, and the Mo content is controlled within the range of 0.05-0.30%.

As previously mentioned, alloying elements such as Ni, Cr, and Mo serve as substitutes to supplement Mn. Their primary role in the present invention is to enhance and reinforce the stability of austenite. However, comprehensively considering multiple factors such as cost, casting difficulty, hot rolling difficulty, cold rolling difficulty, the overall addition of these elements should meet the integrated objectives of low cost, ease of production, and high yield. Therefore, the total content of Mn, Ni, Cr, and Mo is controlled to be less than or equal to 2.5%.
Nb: Nb is a microalloy strengthening element that serves to refine grain structure and enhance strength. In the present invention, Nb is added in combination with Ti to compensate for insufficient strength in some designed compositions. However, the Nb content should not be excessively high, as this will lead to excessive grain refinement during hot rolling, increased strength of the hot-rolled coil, and greater difficulty in cold rolling. In the present invention, the P content is controlled within the range of 0.01-0.025%.

Another aspect of the present invention provides a gradient partitioning preparation method for the above-mentioned quenched and partitioned steel for automobiles, including steps of continuous annealing or continuous annealing galvanizing as follows:

### Continuous Annealing:

Heat a cold-rolled sheet to 800-830 °C and hold it isothermally for 80-180 s, then slowly cool the heated sheet to 700-740 °C at a cooling rate of 1.2-3.6 °C/s, followed by rapidly cooling the sheet to 250-280 °C at a cooling rate of 15-25 °C/s. Subsequently, heat the cooled sheet to 380-410 °C at a heating rate of above 20 °C/s for a first-stage over-aging treatment with an isothermal holding time of 120-280 s, followed by subject the sheet to a second-stage over-aging treatment at an aging temperature of 300-380 °C with an isothermal holding time of 120-280 s.

### Continuous Annealing Galvanizing:

Heat a cold-rolled sheet to 820-860 °C and hold it isothermally for 60-120 s, then slowly cool the heated sheet to 700-740 °C at a cooling rate of 1.2-3.6 °C/s, followed by rapidly cooling the sheet to 250-280 °C at a rate of 18-25 °C/s. Subsequently, heat the cooled sheet to 480-510 °C at a heating rate of above 20 °C/s for an over-aging treatment with an isothermal holding time of 20-40 s, then subject the treated sheet to galvanizing in a zinc bath, at a temperature of 450-470 °C for 2-5 s.

In the above technical solutions, further, a thickness of the cold-rolled sheet is 1.4/1.6/1.8 mm. The 1.4 mm cold-rolled sheet is produced form a 2.8 mm hot-rolled steel sheet, and the 1.6 mm and 1.8 mm cold-rolled sheets are produced from a 3.0-3.5 mm hot-rolled steel sheet.

Reasons for the design of the preparation steps of the present invention are as follows:
During the soaking stage of continuous annealing/continuous annealing galvanizing (continuous annealing at temperature of 800-830 °C with isothermal holing time of 80-180 s, or continuous annealing galvanizing at temperature of 820-860 °C with isothermal holing time of 60-120 s), 35%-45% of critical zone ferrite structure is obtained to balance the strength of the steel sheet and ensure the C concentration in austenite under a certain degree of austenitization. Slow cooling at a rate of 1.2-3.6 °C/s to 700-740 °C results in, 5%-10% of the crystallographically oriented ferrite, preventing excessive ferrite content from reducing the strength of the steel sheet and avoiding insufficient ferrite content leading to excessively high strength of the steel sheet. More importantly, this ensures the C concentration gradient in the undercooled austenite after slow cooling and before rapid cooling, thereby determining the transformation amount of bainite and martensite in subsequent processes. Subsequently, rapid cooling at a higher rate to 250-280 °C yields 25%-30% of, martensite structure and the remaining untransformed undercooled austenite structure. Insufficient martensite content will reduce the strength of the steel sheet, while excessive martensite content will result in a decrease in retained austenite content.

The key processes of the continuous annealing/continuous annealing galvanizing lie in: 1. A rapid heating rate (above 20 °C/s). Slow heating will inhibit the transformation of retained undercooled austenite in the steel sheet into bainite, since the C concentration required for the bainite transformation termination line T₀ gradually decreases during slow heating. 2. Gradient partitioning: The present invention employs a two-stage partitioning treatment, with the first stage at a higher temperature than the second stage, to form a cooling gradient. Since the slow cooling process (naturally cooling of the steel sheet in furnace) will greatly shift the bainite transformation termination line T₀ to the right, thereby increasing the required terminal C concentration, delaying the completion of bainite transformation, greatly increasing the retained austenite content in the steel sheet to over than 15%, and the remaining secondary martensite content is theoretically minimized, greatly enhancing the formability of the steel sheet. Therefore, after the previous process treatment, 25-30% of the undercooled austenite transforms into 12-15 bainite and 15-18% retained austenite, thereby achieving an elongation after fracture of over 25%.

In the above technical solutions, further, the method for preparing the cold-rolled sheet includes the following steps of continuous casting, hot rolling, acid pickling, and cold rolling as follows:
(1) Continuous casting: perform continuous casting according to the chemical components of the steel to obtain a steel slab.
(2) Hot rolling: heat the steel slab at a temperature of 1230-1280 °C in a furnace for 180-240 min, then subject the steel slab to rough rolling at a temperature of 1150-1200 °C, obtain an intermediate slab with a thickness of 50-80 mm, followed by subjecting it to finish rolling at an initial rolling temperature of 1070-1130 °C and then at a final rolling temperature of above 920 °C, then subject the rolled slab to coiling at a temperature of 450-520 °C, and obtain a hot-rolled steel sheet with a thickness of 2.8-3.5 mm.
(3) Acid pickling and cold rolling: perform cold rolling on the hot-rolled steel sheet after acid pickling, with a cold rolling reduction rate of 46.7-48.6%.

In the above technical solutions, further, in step (1), a casting temperature is 1580-1620 °C, and the thickness of the steel slab is 220-280 mm.

Reasons for the design of the preparation method of the cold-rolled sheet of the present invention are as follows:

In step (2), the heating temperature is controlled at 1230-1280 °C, with a time of 180-240 min, aiming to promote the full solid solution of alloys and control banded structures caused by segregation. The two-stage finish rolling is employed aiming to promote recrystallization behavior of original austenite grains and inhibit the coarsening of non-recrystallized austenite grains. The coiling temperature is controlled at 450-520 °C to prevent the formation of Si-rich oxides on the steel sheet surface after the addition of Si to result in the formation of internal oxidation layers and grain boundary oxidation layers.

In step (3), insufficient rolling reduction rate cannot ensure sufficient cold rolling deformation storage energy, resulting in inadequate ferrite recrystallization during the continuous annealing stage. Conversely, excessively high rolling reduction rate greatly increases the load on the cold rolling mill, which may compromise the achievement of the target thickness.

The beneficial effects of the present invention are as follows:
(1) Through rational composition and process design, the present invention breaks through the plasticity limitation mechanism of QP steel by proposing a gradient partitioning process concept. It gives full play to the advantages of bainite-based microstructure, achieving an optimal design of retained austenite content and superior coordinated deformation capability among microstructures. The QP steel product produced by the present invention exhibits a yield strength of 600-660 MPa, a tensile strength of 980-1100 MPa, an elongation of 25-31%. Compared to steel sheets of the same grade, the QP steel of the present invention surpasses international leading levels and can be applied to more complex automotive structural components.
(2) Based on existing equipment conditions, the present invention has the advantages of low production cost and stable manufacturing processes.
(3) The QP steel product of the present invention contributes to automotive lightweighting, enabling weight reduction and at the application end to decrease exhaust emission, align with the dual-carbon strategy.

### BRIEF DESCRIPTION OF THE DRAWINGS

The sole FIGURE shows the scanning microstructure of Example 1 of the present invention.

### DETAILED DESCRIPTION OF THE EMBODIMENTS

The present invention is described in detail through the examples below, which are provided only to describe preferred implementations of the present invention and do not limit the scope of the present invention in any way.

### Examples 1 to 10

The chemical components of the quenched and partitioned steel for automobiles provided in Examples 1 to 10 are shown in Table 1.

Table 1 Chemical components of steel in Examples 1 to 10, wt %

| | | | | | | | | Mn + | | | |
|---|---|---|---|---|---|---|---|---|---|---|---|
| | | | | | | | | Ni + | | | |
| C | Mn | Si | Al | Ti | Ni | Cr | Mo | Cr + Mo | Nb | P | S |
| 0.185 | 2.32 | 1.72 | 0.015 | 0.018 | — | — | — | 2.32 | 0.012 | 0.009 | 0.001 |
| 0.193 | 2.15 | 1.65 | 0.015 | 0.015 | — | 0.15 | 0.1 | 2.4 | 0.018 | 0.01 | 0.002 |
| 0.226 | 1.98 | 1.58 | 0.015 | 0.017 | 0.1 | 0.1 | — | 2.18 | 0.023 | 0.009 | 0.003 |
| 0.208 | 2.04 | 1.71 | 0.015 | 0.022 | — | — | — | 2.04 | 0.015 | 0.01 | 0.004 |
| 0.236 | 1.75 | 1.53 | 0.015 | 0.023 | 0.2 | — | 0.15 | 2.1 | 0.021 | 0.007 | 0.003 |
| 0.178 | 2.37 | 0.85 | 0.62 | 0.024 | 0.1 | — | — | 2.47 | 0.016 | 0.012 | 0.001 |
| 0.225 | 2.15 | 0.96 | 0.68 | 0.019 | 0.3 | — | — | 2.45 | 0.015 | 0.01 | 0.004 |
| 0.214 | 2.06 | 1.05 | 0.64 | 0.018 | — | — | 0.3 | 2.36 | 0.015 | 0.01 | 0.002 |
| 0.198 | 2.24 | 1.22 | 0.48 | 0.016 | — | — | 0.1 | 2.34 | 0.018 | 0.009 | 0.003 |
| 0.201 | 2.18 | 0.95 | 0.71 | 0.022 | — | 0.3 | 0.05 | 2.48 | 0.015 | 0.007 | 0.002 |

The method for preparing the above-mentioned quenched and partitioned steel for automobiles included steps of continuous casting, hot rolling, acid pickling, cold rolling, continuous annealing or continuous annealing galvanizing as follows:
(1) Continuous casting: performing continuous casting with a casting temperature of 1580-1620 °C according to the chemical components of the steel to obtain a steel slab, with a thickness of 220-280 mm.
(2) Hot rolling: heating the steel slab at a temperature of 1230-1280 °C in a furnace for 180-240 min, then subjecting the steel slab to rough rolling at a temperature of 1150-1200 °C, obtaining an intermediate slab with a thickness of 50-80 mm, followed by subjecting it to finish rolling at an initial rolling temperature of 1070-1130 °C and then at a final rolling temperature of above 920 °C, then subjecting the rolled slab to coiling at a temperature of 450-520 °C, and obtaining a hot-rolled steel sheet with a thickness of 2.8-3.5 mm.
(3) Acid pickling and cold rolling: performing cold rolling on the hot-rolled steel sheet after acid pickling, with a cold rolling reduction rate of 46.7-48.6%. The thickness of the cold-rolled sheet obtained was 1.4 mm/1.6 mm/1.8 mm. The 1.4 mm cold-rolled sheet was produced from a 2.8 mm hot-rolled steel sheet, and the 1.6 mm and 1.8 mm cold-rolled sheets were produced from a 3.0-3.5 mm hot-rolled steel sheet.
(4) Continuous annealing:
Heating the cold-rolled steel sheet to 800-830 °C and holding it isothermally for 80-180 s, then slowly cooling the heated sheet to 700-740 °C at a cooling rate of 1.2-3.6 °C/s, followed by rapidly cooling it to 250-280 °C at a cooling rate of 15-25 °C/s, and then heating the cooled sheet to 380-410 °C at a heating rate of above 20 °C/s for a first-stage over-aging treatment with an isothermal holing time of 120-280 s, followed by subjecting it to a second-stage over-aging treatment at an aging temperature of 300-380 °C with an isothermal holding time of 120-280 s; or
Continuous annealing galvanizing:
Heating the cold-rolled sheet to 820-860 °C and holding it isothermally for 60-120 s, then slowly cooling the heated sheet to 700-740 °C at a cooling rate of 1.2-3.6 °C/s, followed by rapidly cooling it to 250-280 °C at a cooling rate of 18-25 °C/s, and then heating the cooled sheet to 480-510 °C at a heating rate of above 20 °C/s for an over-aging treatment with an isothermal holding time of 20-40 s, then subjecting the treated sheet to galvanizing in a zinc bath at a temperature of 450-470 °C for 2-5 s.

Process parameters of the continuous casting and hot rolling for the steels in Examples 1 to 10 are listed in Table 2, while the process parameters of the cold rolling and continuous annealing/continuous annealing galvanizing for steels in Examples 1 to 10 are listed in Table 3.

Table 2 Process parameters of the continuous casting and hot rolling for the steels in Examples 1 to 10

| | | | | | Rough | Intermediate | Initial | Final | |
|---|---|---|---|---|---|---|---|---|---|
| | Continuous | Steel | | | rolling | slab | rolling | rolling | Coiling |
| | casting | slab | Heating | Time in | temperature/ | thickness/ | temperature | temperature | temperature |
| Example | temperature | thickness | temperature | furnace/min | °C | mm | [symbol] | [symbol] | [symbol] |
| 1 | 1590 | 230 | 1256 | 195 | 1187 | 56 | 1075 | 928 | 458 |
| 2 | 1595 | 240 | 1272 | 205 | 1184 | 68 | 1122 | 922 | 475 |
| 3 | 1616 | 220 | 1265 | 215 | 1176 | 58 | 1078 | 937 | 508 |
| 4 | 1618 | 240 | 1258 | 225 | 1152 | 72 | 1085 | 954 | 512 |
| 5 | 1585 | 250 | 1267 | 185 | 1191 | 80 | 1092 | 925 | 509 |
| 6 | 1587 | 280 | 1276 | 240 | 1156 | 50 | 1113 | 921 | 513 |
| 7 | 1605 | 270 | 1274 | 230 | 1174 | 60 | 1125 | 926 | 484 |
| 8 | 1601 | 260 | 1253 | 220 | 1182 | 72 | 1105 | 934 | 462 |
| 9 | 1586 | 250 | 1237 | 230 | 1193 | 65 | 1084 | 938 | 475 |
| 10 | 1615 | 240 | 1235 | 240 | 1178 | 55 | 1096 | 922 | 455 |

[symbol]

indicates data missing or illegible when filed

Table 3 Process parameters of the cold rolling and continuous annealing/continuous annealing galvanizing for the steels in Examples 1 to 10

| | | | | | | | | | First- | Second-stage | |
|---|---|---|---|---|---|---|---|---|---|---|---|
| | | | | | | | | | stage | over-aging | Second-stage |
| | | | Slow | | Rapid | Rapid | | First-stage | over- | temperature | over-aging |
| | Heating | Isothermal | cooling | Slow cooling | cooling | cooling | Heating | over-aging | aging | (or galvanizing | holding time |
| | temperature | holding | rate/ | temperature/ | rate/ | temperature/ | rate/ | temperature/ | holding | temperature)/ | (galvanizing |
| Example | [symbol] | [symbol] | °C/s | °C | °C/s | °C | °C/s | °C | time/s | °C | time)/s |
| 1 | 825 | 95 | 708 | 2.56 | 16.6 | 252 | 25.2 | 408 | 140 | 305 | 120 |
| 2 | 808 | 105 | 725 | 1.75 | 18.5 | 267 | 26.4 | 402 | 260 | 348 | 260 |
| 3 | 821 | 145 | 734 | 1.26 | 22.4 | 277 | 26.4 | 396 | 180 | 337 | 150 |
| 4 | 816 | 180 | 716 | 2.28 | 23.4 | 255 | 24.1 | 385 | 270 | 362 | 180 |
| 5 | 813 | 135 | 722 | 3.52 | 20.8 | 263 | 20.8 | 392 | 130 | 372 | 190 |
| 6 | 854 | 26 | 732 | 1.69 | 19.6 | 257 | 20.7 | 508 | 25 | 462 | 2 |
| 7 | 836 | 34 | 725 | 2.54 | 21.2 | 266 | 21.6 | 496 | 35 | 459 | 5 |
| 8 | 842 | 28 | 716 | 1.98 | 24.6 | 273 | 22.5 | 488 | 40 | 465 | 5 |
| 9 | 836 | 39 | 709 | 3.42 | 20.4 | 268 | 21.8 | 495 | 20 | 455 | 4 |
| 10 | 825 | 26 | 724 | 3.11 | 21.5 | 251 | 20.9 | 482 | 25 | 458 | 3 |

[symbol]

indicates data missing or illegible when filed

Table 4 shows the mechanical properties of the steels in Examples 1 to 10.

Table 4 Mechanical properties of the steels in in Examples 1 to 10

| | | | | | Crystallo- | | | |
|---|---|---|---|---|---|---|---|---|
| | Yield | Tensile | | | graphically | | | Retained |
| | strength/ | strength/ | Elongation/ | Intercritical | oriented | Martensite/ | Bainite/ | austenite/ |
| Example | MPa | MPa | % | ferrite/% | ferrite/% | % | % | % |
| 1 | 634 | 1024 | 26.8 | 36.4 | 5.6 | 27.4 | 16.8 | 15.6 |
| 2 | 618 | 1028 | 27.5 | 35.4 | 7.8 | 28.2 | 17.2 | 15.8 |
| 3 | 654 | 1036 | 27.9 | 39.5 | 9.2 | 29.6 | 17.8 | 16.2 |
| 4 | 682 | 1018 | 28.2 | 41.2 | 6.7 | 26.7 | 15.8 | 15.4 |
| 5 | 625 | 1033 | 27.9 | 42.6 | 6.3 | 25.8 | 15.6 | 16.3 |
| 6 | 648 | 1064 | 25.4 | 38.7 | 8.2 | 26.4 | 15.2 | 15.8 |
| 7 | 644 | 1058 | 26.8 | 39.4 | 8.6 | 27.3 | 16.4 | 16.2 |
| 8 | 635 | 1074 | 25.3 | 40.8 | 7.8 | 25.4 | 17.6 | 15.3 |
| 9 | 647 | 1055 | 26.2 | 38.6 | 8.4 | 26.8 | 17.2 | 15.8 |
| 10 | 628 | 1059 | 25.9 | 42.5 | 7.9 | 27.7 | 16.9 | 16.8 |

The above examples are merely preferred implementations of the present invention, and are not intended to limit the implementations. The protection scope of the present invention shall be subject to the scope defined by the claims. On the basis of the above description, other changes or variations in different forms can be also made. Obvious changes or variations derived therefrom remain within the protection scope of the present invention.

1. A quenched and partitioned steel for automobiles, wherein the steel comprises the following chemical components in percentage by mass: 0.17-0.24% of C, 1.60-2.40% of Mn, 0.80-1.80% of Si, 0.05-0.80% of Al, 0.015-0.025% of Ti, 0.007-0.012% of P, 0.001-0.004% of S, and a balance of Fe and inevitable impurities.

2. The quenched and partitioned steel for automobiles according to claim 1, wherein the chemical components of the steel further comprises at least one of Ni, Cr, Mo and Nb, with their contents in percentage by mass of 0.10-0.30% of Ni, 0.10-0.30% of Cr, 0.05-0.30% of Mo, and 0.015-0.025% of Nb, with a total mass of Mn, Ni, Cr and Mo of less than or equal to 2.50%.

3. The quenched and partitioned steel for automobiles according to claim 1, wherein the steel has a yield strength of 600-700 Mpa, a tensile strength of 980-1100 Mpa, and an elongation of 25-30%.

4. The quenched and partitioned steel for automobiles according to claim 1, wherein a microstructure of the steel is composed of, in percentage by volume, 40-60% of ferrite, 20-30% of martensite, 10-20% of bainite, and 10-20% of retained austenite, wherein the ferrite is intercritical ferrite and epitaxial ferrite.

5. A gradient partitioning preparation method for the quenched and partitioned steel for automobiles according to claim 1, comprising steps of continuous annealing or continuous annealing galvanizing as follows:
continuous annealing:
heating a cold-rolled sheet to 800-830 °C and holding it isothermally for 80-180 s, then slowly cooling the heated sheet to 700-740 °C at a cooling rate of 1.2-3.6 °C/s, followed by rapidly cooling it to 250-280 °C at a cooling rate of 15-25 °C/s, and then heating the cooled sheet to 380-410 °C at a heating rate of above 20 °C/s for a first-stage over-aging treatment with an isothermal holing time of 120-280 s, followed by subjecting it to a second-stage over-aging treatment at an aging temperature of 300-380 °C with an isothermal holding time of 120-280 s; or
continuous annealing galvanizing:
heating a cold-rolled sheet to 820-860 °C and holding it isothermally for 60-120 s, then slowly cooling the heated sheet to 700-740 °C at a cooling rate of 1.2-3.6 °C/s, followed by rapidly cooling it to 250-280 °C at a cooling rate of 18-25 °C/s, and then heating the cooled sheet to 480-510 °C at a heating rate of above 20 °C/s for an over-aging treatment with an isothermal holding time of 20-40 s, then subjecting the treated sheet to galvanizing in a zinc bath at a temperature of 450-470 °C for 2-5 s.

6. The preparation method according to claim 5, wherein a thickness of the cold-rolled sheet is 1.4 mm/1.6 mm/1.8 mm, wherein the 1.4 mm cold-rolled sheet is produced from a 2.8 mm hot-rolled steel sheet, and the 1.6 mm and 1.8 mm cold-rolled sheets are produced from a 3.0-3.5 mm hot-rolled steel sheet.

7. The preparation method according to claim 5, wherein a method for preparing the cold-rolled sheet comprises steps of continuous casting, hot rolling, acid pickling, and cold rolling as follows:
(1) continuous casting: performing continuous casting according to the chemical components of the steel to obtain a steel slab;
(2) hot rolling: heating the steel slab at a temperature of 1230-1280 °C in a furnace for 180-240 min, then subjecting the steel slab to rough rolling at a temperature of 1150-1200 °C, obtaining an intermediate slab with a thickness of 50-80 mm, followed by subjecting it to finish rolling at an initial rolling temperature of 1070-1130 °C and then at a final rolling temperature of above 920 °C, then subjecting the rolled slab to coiling at a temperature of 450-520 °C, and obtaining a hot-rolled steel sheet with a thickness of 2.8-3.5 mm; and
(3) acid pickling and cold rolling: performing cold rolling on the hot-rolled steel sheet after acid pickling, with a cold rolling reduction rate of 46.7-48.6%.

8. The preparation method according to claim 7, wherein in step (1), a casting temperature is 1580-1620 °C, and a thickness of the steel slab is 220-280 mm.
